(19) United States
(12) Patent Application Publication
(10) Pub. No.: US 2025/0233275 A1
(43) Pub. Date: Jul. 17, 2025

(54) MULTI-PIECE BUSBAR ASSEMBLIES FOR TRACTION BATTERY ARRAYS

(71) Applicant: FORD GLOBAL TECHNOLOGIES, LLC, Dearborn, MI (US)

(72) Inventors: Francisco Fernandez-Galindo, Canton, MI (US); Daniel Paul Roberts, Livonia, MI (US); Liam E. West, Ferndale, MI (US)

(21) Appl. No.: 18/409,994

(22) Filed: Jan. 11, 2024

(51) Int. Cl. H01M 50/507; H01M 50/516; H01M 50/553; H01M 50/566

(52) U.S. Cl. CPC H01M 50/507; H01M 50/516; H01M 50/553; H01M 50/566; H01M 2220/20

(57) ABSTRACT

Battery arrays are provided for traction battery packs. An exemplary battery array may include a multi-layered busbar assembly having at least a first busbar layer and a second busbar layer. Battery cell tab terminals may be trapped between the first busbar layer and the second busbar layer of the busbar assembly. The battery cell tab terminals, the first busbar layer, and the second busbar layer may then be fused together, such as by one or more welds, to electrically connect a grouping of battery cells of the array.

### TECHNICAL FIELD

This disclosure relates generally to electrified vehicle traction battery packs, and more particularly to multi-piece busbar assemblies and associated methods for electrically connecting a grouping of battery cells within a battery array of a traction battery pack.

### BACKGROUND

Electrified vehicles include a traction battery pack for powering electric machines and other electrical loads of the vehicle. The traction battery pack includes a plurality of battery cells and various other battery internal components that support electric vehicle propulsion.

### SUMMARY

A battery array for a traction battery pack according to an exemplary aspect of the present disclosure includes, among other things, a busbar assembly including a first busbar layer and a second busbar layer, and a battery cell including a cell tab terminal that is trapped between the first busbar layer and the second busbar layer.

In a further non-limiting embodiment of the foregoing battery array, the cell tab terminal extends through an opening of the first busbar layer and is bent over a first backing tab of the first busbar layer.

In a further non-limiting embodiment of either of the foregoing battery arrays, a second backing tab of the second busbar layer is received over a portion of the cell tab terminal that is bent over the first backing tab.

In a further non-limiting embodiment of any of the foregoing battery arrays, a weld joins together the second backing tab of the second busbar layer, the portion of the cell tab terminal, and the first backing tab of the first busbar layer.

In a further non-limiting embodiment of any of the foregoing battery arrays, the weld is a laser weld.

In a further non-limiting embodiment of any of the foregoing battery arrays, a second battery cell includes a second cell tab terminal that is trapped between the first busbar layer and the second busbar layer.

In a further non-limiting embodiment of any of the foregoing battery arrays, the second cell tab terminal extends through a second opening of the first busbar layer and is bent over a third backing tab of the first busbar layer.

In a further non-limiting embodiment of any of the foregoing battery arrays, a fourth backing tab of the second busbar layer is received over a portion of the second cell tab terminal that is bent over the third backing tab.

In a further non-limiting embodiment of any of the foregoing battery arrays, the busbar assembly is held within a busbar module frame of a busbar module.

In a further non-limiting embodiment of any of the foregoing battery arrays, the busbar module frame includes a stake that is received through a first mounting hole of the first busbar layer and a second mounting hole of the second busbar layer.

In a further non-limiting embodiment of any of the foregoing battery arrays, the second mounting hole is keyhole shaped.

In a further non-limiting embodiment of any of the foregoing battery arrays, a design of the second busbar layer mimics that of the first busbar layer.

In a further non-limiting embodiment of any of the foregoing battery arrays, each of the first busbar layer and the second busbar layer includes a mounting bracket.

In a further non-limiting embodiment of any of the foregoing battery arrays, the cell tab terminal includes at least one bend for establishing a strain relief area of the cell tab terminal.

In a further non-limiting embodiment of any of the foregoing battery arrays, a weld joins together the second busbar layer, the cell tab terminal, and the first busbar layer.

A method according to another exemplary aspect of the present disclosure includes, among other things, trapping a cell tab terminal of a battery cell between a first busbar layer and a second busbar layer of a busbar assembly, and fusing the second busbar layer, the cell tab terminal, and the first busbar layer together.

In a further non-limiting embodiment of the foregoing method, trapping the cell tab terminal between the first busbar layer and the second busbar layer includes translating the second busbar layer in a side-to-side direction relative to the first busbar layer.

In a further non-limiting embodiment of either of the foregoing methods, the method includes bending the cell tab terminal over a backing tab of the first busbar layer prior to or while translating the second busbar layer relative to the first busbar layer.

In a further non-limiting embodiment of any of the foregoing methods, translating the second busbar layer in the side-to-side direction relative to the first busbar layer includes positioning a stake of a busbar module frame into engagement with a keyhole shaped mounting hole of the second busbar layer to lock the second busbar layer in place directly over top of the first busbar layer.

In a further non-limiting embodiment of any of the foregoing methods, fusing the second busbar layer, the cell tab terminal, and the first busbar layer together includes welding the second busbar layer, the cell tab terminal, and the first busbar layer together.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates an electrified vehicle.

FIG. 2 illustrates a battery array of a traction battery pack.

FIG. 3 illustrates the battery array of FIG. 2 with portions of an array housing removed for better illustrating a cell stack and a pair of bus bar modules of the battery array.

FIG. 4 is a blown up and exploded view of select portions of the battery array of FIG. 3.

FIG. 5 schematically illustrates a step of a method for electrically connecting a grouping of battery cells with a busbar assembly.

FIG. 6 schematically illustrates another step of a method for electrically connecting a grouping of battery cells with a busbar assembly.

FIG. 7 is a cross-sectional view through section 7-7 of FIG. 6.

### DETAILED DESCRIPTION

This disclosure details battery arrays for traction battery packs. An exemplary battery array may include a multi-layered busbar assembly having at least a first busbar layer and a second busbar layer. Battery cell tab terminals may be trapped between the first busbar layer and the second busbar layer of the busbar assembly. The battery cell tab terminals, the first busbar layer, and the second busbar layer may then be fused together, such as by one or more welds, to electrically connect a grouping of battery cells of the array. These and other features are discussed in greater detail in the following paragraphs of this detailed description.

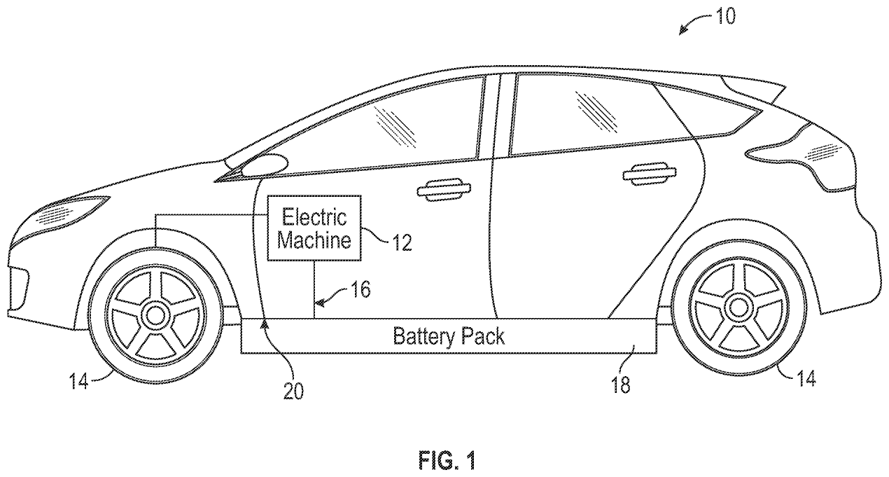

FIG. 1 schematically illustrates an electrified vehicle 10. The electrified vehicle 10 may include any type of electrified powertrain. In an embodiment, the electrified vehicle 10 is a battery electric vehicle (BEV). However, the concepts described herein are not limited to BEVs and could extend to other electrified vehicles, including, but not limited to, hybrid electric vehicles (HEVs), plug-in hybrid electric vehicles (PHEV's), fuel cell vehicles, etc. Therefore, although not specifically shown in the exemplary embodiment, the powertrain of the electrified vehicle 10 could be equipped with an internal combustion engine that can be employed either alone or in combination with other power sources to propel the electrified vehicle 10.

In the illustrated embodiment, the electrified vehicle 10 is depicted as a car. However, the electrified vehicle 10 could alternatively be a sport utility vehicle (SUV), a van, a pickup truck, or any other vehicle configuration. Although a specific component relationship is illustrated in the figures of this disclosure, the illustrations are not intended to limit this disclosure. The placement and orientation of the various components of the electrified vehicle 10 are shown schematically and could vary within the scope of this disclosure. In addition, the various figures accompanying this disclosure are not necessarily drawn to scale, and some features may be exaggerated or minimized to emphasize certain details of a particular component or system.

In an embodiment, the electrified vehicle 10 is a full electric vehicle propelled solely through electric power, such as by one or more electric machines 12, without any assistance from an internal combustion engine. The electric machine 12 may operate as an electric motor, an electric generator, or both. The electric machine 12 receives electrical power and can convert the electrical power to torque for driving one or more wheels 14 of the electrified vehicle 10.

A voltage bus 16 may electrically couple the electric machine 12 to a traction battery pack 18. The traction battery pack 18 is an exemplary electrified vehicle battery. The traction battery pack 18 may be a high voltage traction battery pack assembly that includes a plurality of battery cell groupings capable of outputting electrical power to power the electric machine 12 and/or other electrical loads of the electrified vehicle 10. Other types of energy storage devices and/or output devices could alternatively or additionally be used to electrically power the electrified vehicle 10.

The traction battery pack 18 may be secured to an underbody 20 of the electrified vehicle 10. However, the traction battery pack 18 could be located elsewhere on the electrified vehicle 10 within the scope of this disclosure.

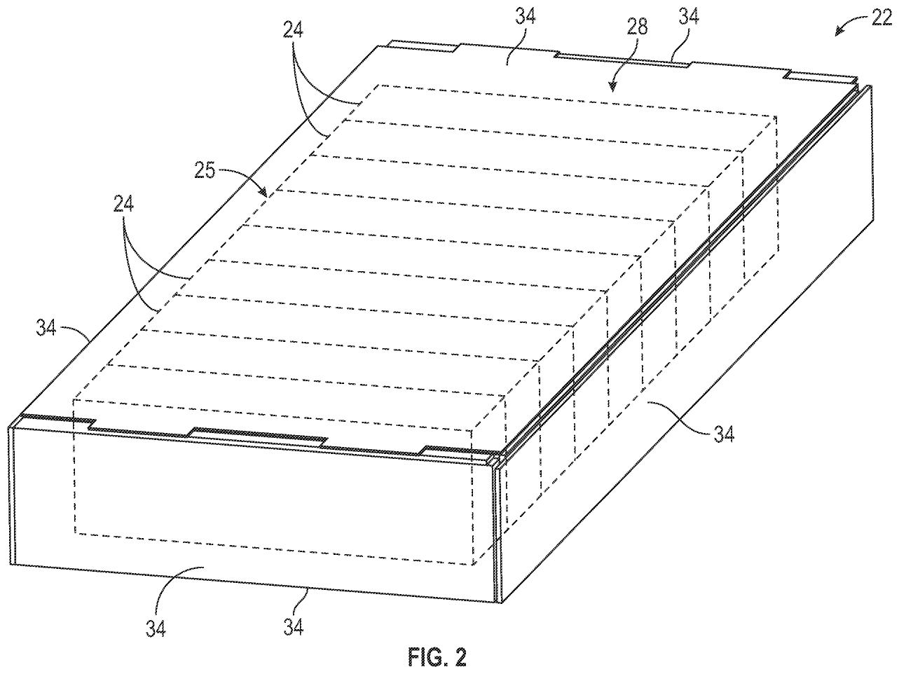

FIGS. 2, 3, and 4 illustrate an exemplary battery array 22 for a traction battery pack, such as the traction battery pack 18 of FIG. 1, for example. One or more battery arrays having a design similar to the battery array 22 shown in FIGS. 2-4 could be packaged inside an outer enclosure assembly of the traction battery pack 18.

The battery array 22 may include a plurality of battery cells 24. In an embodiment, the battery cells 24 are lithium-ion pouch cells. However, battery cells having other geometries (cylindrical, prismatic, etc.) and/or chemistries (nickel-metal hydride, lead-acid, etc.) could alternatively be utilized within the scope of this disclosure. The total number of battery cells 24 provided within the battery array 22 could vary and is thus not intended to limit this disclosure.

The battery cells 24 may be stacked side-by-side along a stack axis to construct a grouping of battery cells 24. The grouping of battery cells 24 may be referred to as a cell stack 25. The cell stack 25 may be subdivided into two or more cell banks, although the exact configuration of the cell stack 25 is not intended to limit this disclosure.

The cell stack 25 may be arranged to extend between a pair of busbar modules 26 that are configured to electrically connect the battery cells 24 of the cell stack 25. One busbar module 26 may be disposed along each longitudinal side of the cell stack 25, for example.

Each busbar module 26 may include a plurality of busbar assemblies 32 held within a busbar module frame 30. Each busbar assembly 32 may be configured to electrically connect a grouping of the battery cells 24 (e.g., one of the cell banks) of the cell stack 25, for example. The total number of busbar assemblies 32 provided as part of each busbar module 26 is not intended to limit this disclosure.

The busbar assemblies 32 may be metallic components of the busbar modules 26, and the busbar module frame 30 may be a plastic component of the busbar modules 26. In an embodiment, the busbar assemblies 32 are made of copper or aluminum, and the busbar module frames 30 are made of polypropylene or polyethylene. However, other materials are contemplated within the scope of this disclosure.

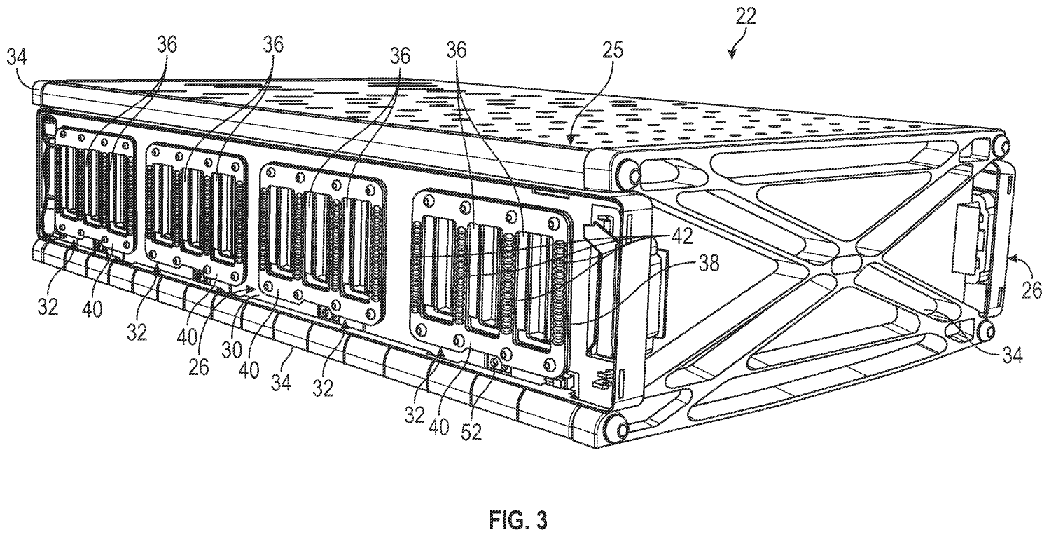

The battery cells 24, the busbar modules 26, and various outer internal components of the battery array 22 may be housed within an array housing 28 (best shown in FIG. 2; portions of the array housing 28 are removed in FIG. 3 for clarity). The array housing 28 may be arranged to substantially surround the cell stack 25 of battery cells 24, for example. The array housing 28 may include a plurality of plate members 34. In an embodiment, the plate members 34 may be arranged to provide a top cover, a bottom cover, a pair of side covers, and a pair of end covers of the battery array 22. However, the specific configuration of the array housing 28 is not intended to limit this disclosure, and thus other array housing configurations are contemplated within the scope of this disclosure. Each busbar module 26 may be positioned between the cell stack 25 and one of the plate members 34.

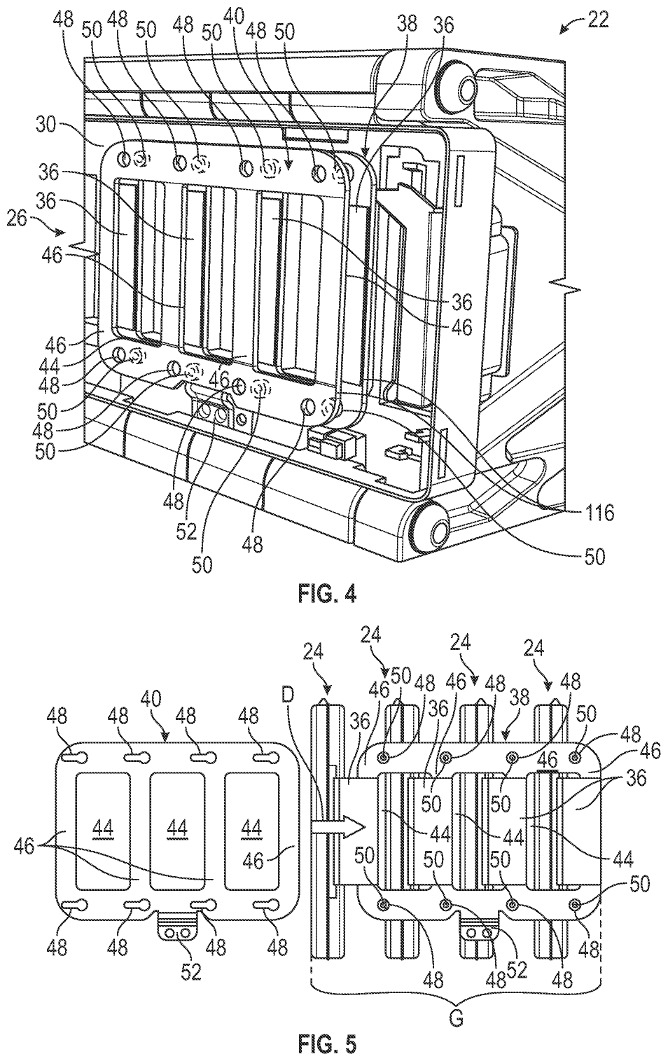

Referring now primarily to FIGS. 3 and 4, the busbar module frame 30 of each busbar module 26 may include a plurality of slots (not shown) that are each sized and shaped for receiving a cell tab terminal 36 of one of the battery cells 24. Each cell tab terminal 36 may project outwardly from a housing of its respective battery cell 24 and may extend through the busbar module frame 30 such that at least a portion of each cell tab terminal 36 is located on an opposite side of the busbar module frame 30 from its respective battery cell 24.

Neighboring cell tab terminals 36, such as those associated with one of the cell banks of the cell stack 25, for example, may be jointed together by one of the busbar assemblies 32 for electrically connecting the battery cells 24 of the battery array 22 to one another. Once electrically coupled by the busbar assemblies 32, the battery cells 24 may supply electrical power necessary for achieving electric propulsion of the electrified vehicle 10.

Each busbar assembly 32 may include a bottom or first busbar layer 38 and a top or second busbar layer 40. The first busbar layer 38 may be attached to the busbar module frame 30, and the second busbar layer 40 may be secured in place over top of the first busbar layer 38 to establish the busbar module assembly 32. In an embodiment, the design (e.g., size, shape, features, etc.) of the second busbar layer 40 mimics that of the first busbar layer 38.

The second busbar layer 40 may be positioned such that the cell tab terminals 36 of a grouping of the battery cells 24 of the cell stack 25 are sandwiched or trapped between the first busbar layer 38 and the second busbar layer 40. The first busbar layer 38, the cell tab terminals 36, and the second busbar layer 40 may then be joined together by one or more welds 42 (see FIG. 4) to electrically connect the subgrouping of battery cells 24. In an embodiment, the welds 42 are laser welds formed during a laser welding process. However, other welding processes could be utilized within the scope of this disclosure.

The first busbar layer 38 and the second busbar layer 40 may each include a plurality of openings 44. In an embodiment, the openings 44 are rectangular openings, however other shapes are contemplated within the scope of this disclosure. The openings 44 may be separated from one another by backing tabs 46. The cell tab terminals 36 may protrude through the openings 44 of the first busbar layer 38 prior to being bent and trapped between the backing tabs 46 of the first busbar layer 38 and the second busbar layer 40. The backing tabs 46 may provide relatively flat surfaces for fusing the first busbar layer 38, the cell tab terminals 36, and the second busbar layer 40 together via the welds 42.

The first busbar layer 38 and the second busbar layer 40 may each additionally include a plurality of mounting holes 48. Stakes 50 of the busbar module frame 30 may be received through the respective mounting holes 48 of the first busbar layer 38 and the second busbar layer 40 for mounting the first busbar layer 38 and the second busbar layer 40 relative to the busbar module frame 30. The heads of the stakes 50 may subsequently be deformed, such as via heat staking or cold working, for example, to secure the first busbar layer 38 and the second busbar layer 40 relative to the busbar module frame 30.

The mounting holes 48 may be round (see FIG. 4) or could alternatively include a keyhole shaped design (see FIG. 5) for facilitating a side-to-side translation and attachment of the second busbar layer 40 over top of the first busbar layer 38.

The first busbar layer 38 and the second busbar layer 40 may each further include one or more mounting brackets 52. Fasteners (not shown) could be inserted through the mounting brackets 52 for securing the first busbar layer 38 and the second busbar layer 40 together and/or to the busbar module frame 30.

FIGS. 5, 6, and 7, with continued reference to FIGS. 3-4, schematically illustrates a method for electrically connecting a grouping G of the battery cells 24 with one of the busbar assemblies 32. The grouping G may establish a cell bank of the cell stack 25, for example. Notably, portions of the busbar module frame 30 are removed in FIGS. 5-7 for better emphasizing various aspects of the exemplary design and method.

The first busbar layer 38 may first be arranged relative to the grouping G of battery cells 24 such that the cell tab terminals 36 extend through the openings 44 (see FIG. 5). The second busbar layer 40 may then be moved in a side-to-side direction D from the position shown in FIG. 5 to the position shown in FIG. 6. The second busbar layer 40 could be positioned substantially over top of the first busbar layer 38 prior to moving the second busbar layer 40 in the side-to-side direction D. As the second busbar layer 40 is moved in the side-to-side direction D, the stakes 50 of the busbar module frame 30 may engage the keyhole shaped mounting holes 48 of the second busbar layer 40 to lock the second busbar layer 40 in place directly over top of the first busbar layer 38 and trap the cell tab terminals 36 therebetween.

Movement of the second busbar layer 40 in the side-to-side direction D can bend the cell tab terminals 36 into place over the backing tabs 46 of the first busbar layer 38. Alternatively, the cell tab terminals 36 could be pre-bent over the backing tabs 46 of the first busbar layer 38. Once the second busbar layer 40 is positioned over top of the first busbar layer 38, the cell tab terminals 36 may be trapped between the backing tabs 46 of the first busbar layer 38 and the second busbar layer 40. The first busbar layer 38, the cell tab terminals 36, and the second busbar layer 40 may then be fused together by the welds 42 to electrically connect the grouping G of battery cells 24.

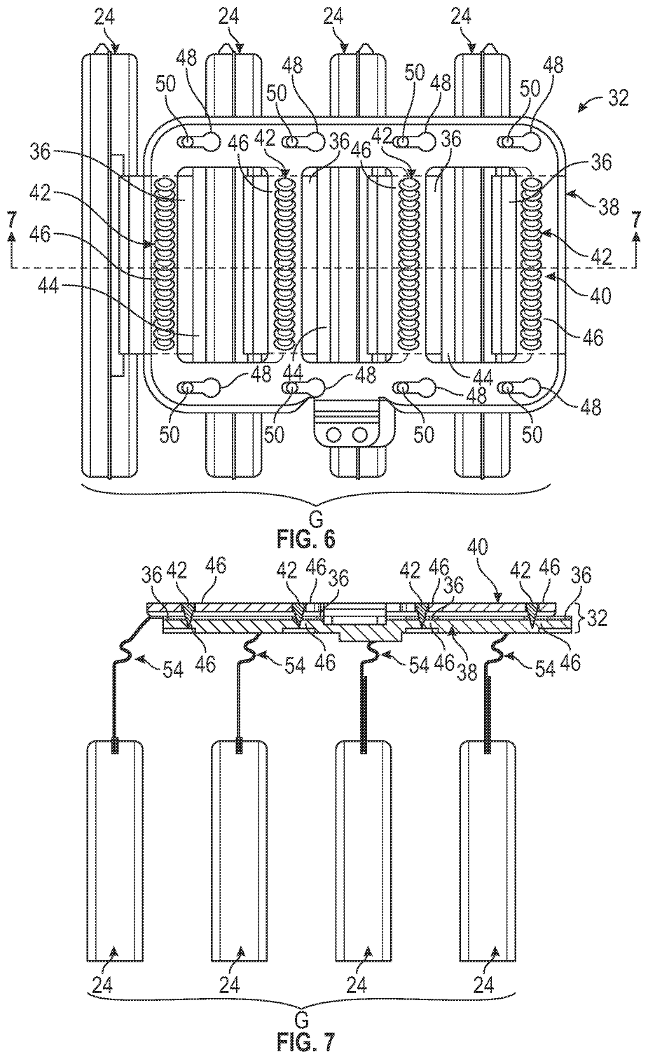

Each cell tab terminal 36 may include one or more bends 54 (see FIG. 7). The bends 54 increase the strength of the cell tab terminals 36 and provide a strain relief area for reducing the potential for vibrational issues during manufacturing.

The exemplary battery arrays of this disclosure include multi-piece busbar assemblies for electrically connecting battery cells of the array. The busbar assemblies may provide numerous advantages over known solutions, including but not limited to providing increased welding flexibility, reduced tolerance constrains, and increased current carrying capability.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A battery array for a traction battery pack, comprising:
a busbar assembly including a first busbar layer and a second busbar layer; and
a battery cell including a cell tab terminal that is trapped between the first busbar layer and the second busbar layer.

2. The battery array as recited in claim 1, wherein the cell tab terminal extends through an opening of the first busbar layer and is bent over a first backing tab of the first busbar layer.

3. The battery array as recited in claim 2, wherein a second backing tab of the second busbar layer is received over a portion of the cell tab terminal that is bent over the first backing tab.

4. The battery array as recited in claim 3, comprising a weld that joins together the second backing tab of the second busbar layer, the portion of the cell tab terminal, and the first backing tab of the first busbar layer.

5. The battery array as recited in claim 4, wherein the weld is a laser weld.

6. The battery array as recited in claim 3, comprising a second battery cell including a second cell tab terminal that is trapped between the first busbar layer and the second busbar layer.

7. The battery array as recited in claim 6, wherein the second cell tab terminal extends through a second opening of the first busbar layer and is bent over a third backing tab of the first busbar layer.

8. The battery array as recited in claim 7, wherein a fourth backing tab of the second busbar layer is received over a portion of the second cell tab terminal that is bent over the third backing tab.

9. The battery array as recited in claim 1, wherein the busbar assembly is held within a busbar module frame of a busbar module.

10. The battery array as recited in claim 9, wherein the busbar module frame includes a stake that is received through a first mounting hole of the first busbar layer and a second mounting hole of the second busbar layer.

11. The battery array as recited in claim 10, wherein the second mounting hole is keyhole shaped.

12. The battery array as recited in claim 1, wherein a design of the second busbar layer mimics that of the first busbar layer.

13. The battery array as recited in claim 1, wherein each of the first busbar layer and the second busbar layer includes a mounting bracket.

14. The battery array as recited in claim 1, wherein the cell tab terminal includes at least one bend for establishing a strain relief area of the cell tab terminal.

15. The battery array as recited in claim 1, comprising a weld that joins together the second busbar layer, the cell tab terminal, and the first busbar layer.

16. A method, comprising:
trapping a cell tab terminal of a battery cell between a first busbar layer and a second busbar layer of a busbar assembly; and
fusing the second busbar layer, the cell tab terminal, and the first busbar layer together.

17. The method as recited in claim 16, wherein trapping the cell tab terminal between the first busbar layer and the second busbar layer includes:
translating the second busbar layer in a side-to-side direction relative to the first busbar layer.

18. The method as recited in claim 17, comprising:
bending the cell tab terminal over a backing tab of the first busbar layer prior to or while translating the second busbar layer relative to the first busbar layer.

19. The method as recited in claim 17, wherein translating the second busbar layer in the side-to-side direction relative to the first busbar layer includes:
positioning a stake of a busbar module frame into engagement with a keyhole shaped mounting hole of the second busbar layer to lock the second busbar layer in place directly over top of the first busbar layer.

20. The method as recited in claim 16, wherein fusing the second busbar layer, the cell tab terminal, and the first busbar layer together includes:
welding the second busbar layer, the cell tab terminal, and the first busbar layer together.
